(19) United States
(12) Patent Application Publication
(10) Pub. No.: US 2010/0178393 A1
(43) Pub. Date: Jul. 15, 2010

(54) DISPOSABLE BOTTLE FOR SUPPLY OF BEVERAGE OF SPECIAL USE FOR BABIES

(76) Inventor: Carmen Paracuellos Pulgarin, Littleton, CO (US)

Correspondence Address: JEROME D. JACKSON (JACKSON PATENT LAW OFFICE), 211 N. UNION STREET, SUITE 100, ALEXANDRIA, VA, 22314, US

(21) Appl. No.: 12/526,954

(22) PCT Filed: Apr. 8, 2008
(86) PCT No.: PCT/ES2008/000224

§ 371 Date: Mar. 4, 2010

(30) Foreign Application Priority Data
Apr. 19, 2007 (ES) U200700808

(51) Int. Cl. B65D 85/816; A61J 9/00

(52) U.S. Cl. 426/86; 426/117

(57) ABSTRACT

Disposable bottle for supply of beverage, of special use for babies, with fastening means which externally attach the hermetic container to the body; said container is designed to hold liquid and has an upper element consisting in both a cup and a dispenser with the hermetic container detachably integrated in the interior thereof and consisting in a teat, the bottle being a feeding bottle, thereby covering the mouth of the body, characterised in that the body and upper part are disposable, for single use, and in addition having a hermetic container of reduced size which contains a dose of powder product for mixing with the liquid.

### OBJECT OF THE INVENTION

The present invention pertains to the field of containers specially designed to supply beverage to babies, preferably containers of the feeding bottle type.

The primary object of the invention is to develop a hygienic and convenient solution for handling and transporting a liquid as well as a powder product to be mixed with the liquid, and for preparing this mixture in a fast and simple manner to obtain a beverage that can be administered to the baby in any place, for example, powdered milk mixed with water to obtain liquid milk.

Another object of the invention is to form the bottle as a compact and integral assembly with a hermetically sealed container which holds the powdered product, and to make it disposable to avoid the necessity of sanitizing the bottle.

### PRIOR ART

It is customary to find mothers with their babies in public places, while traveling or generally away from the home, who have to feed an infant by means of a baby bottle in which it is necessary to mix powdered milk and water to obtain the liquid milk that is given to the infant. A prior step for using the baby bottle involves its sterilization, so that one needs to have hot water available and also, which is the most bothersome situation, the mother must carry around a large can containing the powdered product, such as powdered milk.

The situation is definitely inconvenient to the mother, especially on the one hand, as regards the need to carry around these elements, particularly the can of powdered milk, which is large in volume, and, on the other hand, with respect to the chore of sterilizing and making the mixture of water and powdered milk with this can, which is not easy to handle, especially when the mother is away from home, as mentioned above.

The same problem occurs in the case of children of older age who drink from a cup connected to the container holding the liquid used to mix with the powdered product in order to prepare the mixture being consumed.

### DESCRIPTION OF THE INVENTION

The disposable bottle for supply of beverage which is the subject of this invention satisfactorily solves the above presented problems through the basic use of a disposable single-use body to hold the liquid used for the mixture, in combination with a hermetically sealed container of reduced size that contains the dose of powdered product to be mixed with the liquid.

Preferably, the bottle consists of a baby bottle which forms an integral assembly with the mentioned hermetically sealed container, being easy to transport and handle, since the hermetically sealed container holds the necessary dose for mixing with the liquid, for example, powdered milk, which is mixed with water to produce the milk.

The body of the bottle can be of any shape that is easy to handle and of disposable material, for a single use, preferably being designed of transparent plastic or glass, without rejecting the use of any other material that may be recyclable.

The size of the body of the bottle will be adequate for its transport.

Complementary to the body and hermetically sealed container, the bottle has an upper element that covers the body, which could consist of a nipple in the event that the bottle is a baby bottle, or a cover such as a cup or dispenser, in the event that the bottle is used alternatively to supply beverage to children of older age

The hermetically sealed container can consist of an envelope of reduced size and of any possible configuration, being associated preferably with the body of the bottle.

The bottle of this invention offers a convenient solution, since it allows the beverage to be obtained at a time prior to its consumption, thus guaranteeing that the beverage is fresh, and it is rapid in operation, since a simple tearing of the hermetically sealed container makes it possible for the product contained inside to be discharged and then poured into the body which contains the water, which has been previously warmed or is at room temperature, to make the beverage which will be consumed.

In general manner, the hermetically sealed container of powdered product will be fastened to the body of the bottle, adopting various possible solutions, such as the container is attached to the body externally by fastening means which could be broken or torn to facilitate inverting the hermetically sealed container once opened, thereby pouring its contents into the body, where they are mixed with the liquid to obtain the beverage ready for consumption.

As an example, one could mention a possible solution in which the fastening means could consist of a cord which connects the container to the body of the bottle, and in another possible solution the hermetically sealed container could be glued to the body of the bottle.

Preferably, it is envisioned that the bottle is of the baby bottle type, formed essentially by the body, a nipple, and the container of powdered product.

In another possible application, the bottle can be used for children of older age no longer using the baby bottle, but drinking the contents of a bottle which incorporates a cover in the form of a cup or a dispenser which can be coupled at the top on the body of the bottle.

In this case, the container forms an assembly with the body of the bottle, as in the previous case.

An alternative solution contemplates the possibility that the upper element, whether the nipple or the cup, has the hermetically sealed container integrated inside it by corresponding fastening means, provided that hygienic conditions for the bottle are maintained.

On the other hand, it is contemplated that the bottle also has a plastic piece which attaches the container to the upper sector of the body.

### DESCRIPTION OF THE DRAWINGS

To supplement the description herein provided and in order to assist in a better understanding of the characteristics of the invention, in accordance with a preferred example of embodiment of same, a set of drawings is provided as an integral part of said description, showing in illustrative and non-limiting fashion the following:

FIG. 1—Shows a perspective view of a bottle according to the invention for a baby bottle embodiment, incorporating the hermetically sealed container with the powdered product inside it.

FIG. 2—Shows a perspective view of a bottle according to a second embodiment of the invention for the bottle having an upper lid or cap and the hermetically sealed container with the powdered product inside it.

FIG. 3—Shows a perspective view representing a third embodiment of the bottle with a dispenser as the upper element and

showing the additional incorporation of a plastic piece that attaches the hermetically sealed container to the body.

### PREFERRED EMBODIMENT OF THE INVENTION

With regard to the figures, a preferred embodiment of the disposable bottle (1, 1′) for supply of beverage, being the subject of the present invention, is described below.

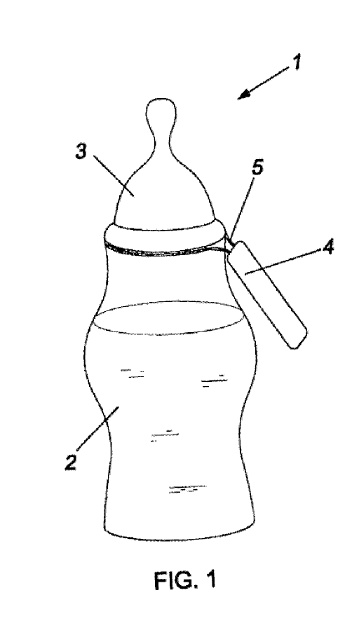

According to the representation in FIG. 1, one notes that the bottle can consist of a disposable bottle (1) of the feeding bottle kind, basically made up of a body (2) open at the top, containing the liquid, and an upper element (3, 3′, 3″) that covers the mouth of the body (2), in this case being a nipple (3).

In this same FIG. 1, it is seen that the disposable bottle (1) additionally comprises a hermetically sealed container (4) of reduced size, which contains a powdered product ready to be mixed with the liquid contained in the body (2) to obtain the beverage.

Likewise, one sees in this FIG. 1 that the hermetically sealed container (4) is connected to the body (2) by certain fastening means (5, 6), which in this case consist of a cord (5), which maintains in an integral and united form the powdered product in the required dose with the body (2) of the feeding bottle.

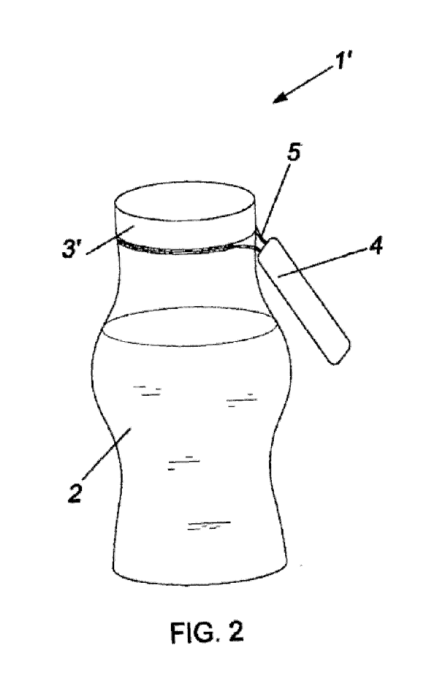

FIG. 2 shows another possible embodiment of the bottle (1) which is the subject of this invention, showing the body (2) and, as the upper element (3, 3′, 3″) covering the mouth of the body (2), one finds a cup (3′). As in the previous case, it has a hermetically sealed container (4) which, once opened, allows for mixing of its contents with the liquid held in the body (2), thus obtaining a beverage that is given to the child by means of the cup (3′).

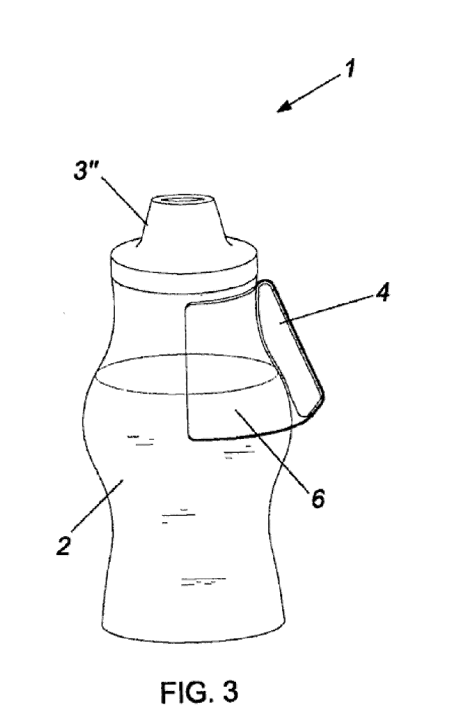

FIG. 3 shows that the fastening means (5, 6) can consist of a plastic piece (6) which joins the hermetically sealed container (4) to the body (2), in which the upper element (3, 3′, 3″) consists of a dispenser (3″).

1. A disposable bottle for supply of beverage, of special use for babies, comprising a body intended to hold the liquid and an upper element which covers the mouth of the body, characterized in that the body and the upper element are disposable, of single use, and additionally has a hermetically sealed container of reduced size, which contains one dose of powdered product to be mixed with the liquid.

2. The disposable bottle for supply of beverage, of special use for babies, according to claim 1, further characterized in that it comprises fastening means which externally connect the hermetically sealed container to the body.

3. The disposable bottle for supply of beverage, of special use for babies, according to claim 1, further characterized in that the upper element integrates the hermetically sealed container on the inside in removable manner.

4. The disposable bottle for supply of beverage, of special use for babies, according to claim 1, further characterized in that the upper element comprises a nipple and the bottle is of the feeding bottle type.

5. The disposable bottle for supply of beverage, of special use for babies, according to claim 1, further characterized in that the upper element comprises a cup.

6. The disposable bottle for supply of beverage, of special use for babies, according to claim 1, further characterized in that the upper element comprises a dispenser.
